(19) United States
(12) Patent Application Publication
(10) Pub. No.: US 2014/0245025 A1
(43) Pub. Date: Aug. 28, 2014

(54) SYSTEM AND METHOD FOR STORING DATA SECURELY

(71) Applicant: SPIDEROAK INC., Northbrook, IL (US)

(72) Inventor: Alan Fairless, Raytown, MO (US)

(73) Assignee: SpiderOak Inc., Northbrook, IL (US)

(21) Appl. No.: 13/841,305

(22) Filed: Mar. 15, 2013

Related U.S. Application Data
(60) Provisional application No. 61/768,377, filed on Feb. 22, 2013.

(51) Int. Cl. G06F 21/60

(52) U.S. Cl. CPC G06F 21/602
USPC 713/189

(57) ABSTRACT

Systems, methods, and media may provide secure data storage. A request may be transmitted for a requested container to a database, the request comprising a requested container identifier of the requested container. The database may comprise containers, wherein each container is identified by a container identifier and comprises at least one record, a container session key table configured to store the container identifiers of the containers, a container session key share table configured to store encrypted user keys, and a container session key table configured to store session key shares, wherein each session key share corresponds to at least one encrypted user key. The requested container may be received from the database, and the database may provide the requested container by using the container session key table to identify the requested container. An encrypted user key corresponding to the requested container may be received from the database, and the requested container and the encrypted user key may be transmitted to an application framework.

### CROSS REFERENCE TO RELATED APPLICATIONS

This application claims priority to U.S. Provisional Patent Application Ser. No. 61/768,377 filed Feb. 22, 2013, entitled “SYSTEM AND METHOD FOR STORING DATA SECURELY”, which is hereby incorporated herein by reference in its entirety.

### FIELD

This disclosure relates generally to storing data securely and more particularly to methods, system, and media for storing data securely.

### BACKGROUND

More people are becoming “privacy aware.” However, the present approaches provided by enterprises allow the developer or service provider to access critical internal data stored by users. Typically, developers or service providers of distributed secure systems manage encryption keys for the user. Although the developers or service providers may restrict access to those encryption keys from unauthorized users, the developers or service providers store the encryption keys. As a result, the developers, service providers, or anyone that gains access to the system may enjoy access to the encryption keys, and consequently, the information being stored using the encryption keys. Although information stored in this manner may appear secure, trusted parties (such as a service providers providing access because of a government warrant) and untrusted parties (such as hackers, scammers, or rogue developers) can access the user's content without the user's authorization, thereby violating the user's trust.

Alternative approaches require securing inherently open environments, such as Dropbox® API or Amazon® S3®. Yet, building and using cryptography code is famously difficult, even for expert application developers.

### SUMMARY

Various embodiments are generally directed to storing data securely to overcome the aforementioned problems.

One or more embodiments may include a method for storing data securely, the method comprising: receiving, by an application framework implemented by a computing system, a payload from an application; receiving, by the application framework, a passphrase; decrypting at least one encrypted user key using the passphrase to produce at least one user key; encrypting the payload using the at least one user key to produce an encrypted payload, and storing or transmitting the encrypted payload.

One or more embodiments may include a method for storing data securely, the method comprising: receiving, by an application framework implemented by a computing system, a payload from an application; receiving, by the application framework, a passphrase; decrypting at least one encrypted user key using the passphrase to produce at least one user key; decrypting the payload using the at least one user key to produce a decrypted payload; and providing, by the application framework, the decrypted payload to the application.

One or more embodiments may include a system for storing data securely, the system comprising: a computing system; and a database comprising: containers, wherein each container is identified by a container identifier and comprises at least one record; a container session key table configured to store the container identifiers of the containers; a container session key share table configured to store encrypted user keys; and a container session key table configured to store session key shares, wherein each session key share corresponds to at least one encrypted user key; wherein the computing system is configured to: transmit a request for a requested container to the database, the request comprising a requested container identifier of the requested container; receive the requested container from the database, wherein the database provides the requested container by using the container session key table to identify the requested container; receive an encrypted user key corresponding to the requested container from the database; and transmit the requested container and the encrypted user key to an application framework.

One or more embodiments may include a computer readable storage medium for storing data securely, the computer readable storage medium comprising instructions that if executed enables a computing system to: transmit a request for a requested container to a database, the request comprising a requested container identifier of the requested container, wherein the database comprises: containers, wherein each container is identified by a container identifier and comprises at least one record, a container session key table configured to store the container identifiers of the containers, a container session key share table configured to store encrypted user keys, and a container session key table configured to store session key shares, wherein each session key share corresponds to at least one encrypted user key; receive the requested container from the database, wherein the database provides the requested container by using the container session key table to identify the requested container; receive an encrypted user key corresponding to the requested container from the database; and transmit the requested container and the encrypted user key to an application framework.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a block diagram of an exemplary system 100 in accordance with one or more embodiments.

FIGS. 2A and 2B depict an exemplary program code listing for using an application framework to interact with a database in accordance with one or more embodiments.

FIG. 3 depicts a block flow diagram of an exemplary method 300 in accordance with one or more embodiments.

FIG. 4 depicts a block flow diagram of an exemplary method 400 in accordance with one or more embodiments.

FIG. 5 depicts a block flow diagram of an exemplary method 500 in accordance with one or more embodiments.

FIG. 6 depicts a data flow diagram 600 in accordance with one or more embodiments.

FIG. 7 depicts an exemplary architecture for implementing a computing device in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

This disclosure describes several exemplary frameworks for building cryptographically secure applications, including the Crypton framework. Such applications offer meaningful privacy assurance to end users because the servers running the application may not be able to read the data stored by end users. This means that developers can, for the first time, build applications that offer total privacy and security “out of the box” without the need for additional security and privacy layers. The framework may transparently handle all the hard parts of cryptography behind the scenes. This allows developers to focus on domain specific challenges and not worry about securing their product after the fact.

Data from the applications may be stored by the framework in an encrypted, multi-user, object database. A server running the database software may be blind to the objects being stored, manipulated, and shared by the users. The users may all use applications built with framework that knows how to retrieve and decrypt objects from the database, and also how to encrypt and store new objects and updates to existing objects. Critically, developers building applications with this framework do not have to understand cryptography, or actually even known that cryptography is happening. They just use the multi user object database as they would any other object database.

The framework may be used to build several types of applications. The most appropriate applications are those with significant personal user generated content, although it is not limited thereto. For example, 37 signals® Basecamp®, a collaborative project management application, is a suitable candidate. Basecamp® provides an interface for organizing todos, tracking one's time, collecting documents, assets, timelines, calendars, and general communication among a group of people working on a specific project. Much of the data used by the application is provided by the users. The software itself is fairly generic—it can work with any combination of documents, calendar events, etc. The server administrators do not profit from seeing this data, and may even cause trouble by accessing it.

Additionally, many applications have a mix of content created by users and data supplied by a server, and may use the framework for the sensitive stuff and traditional storage for community data. For example, an online forum, e.g. Reddit®, may use the framework for features such as the private messaging system where users send messages directly from one account to another, or a user's own list of saved posts and comments.

The framework may implement these features using any or all of the techniques described herein.

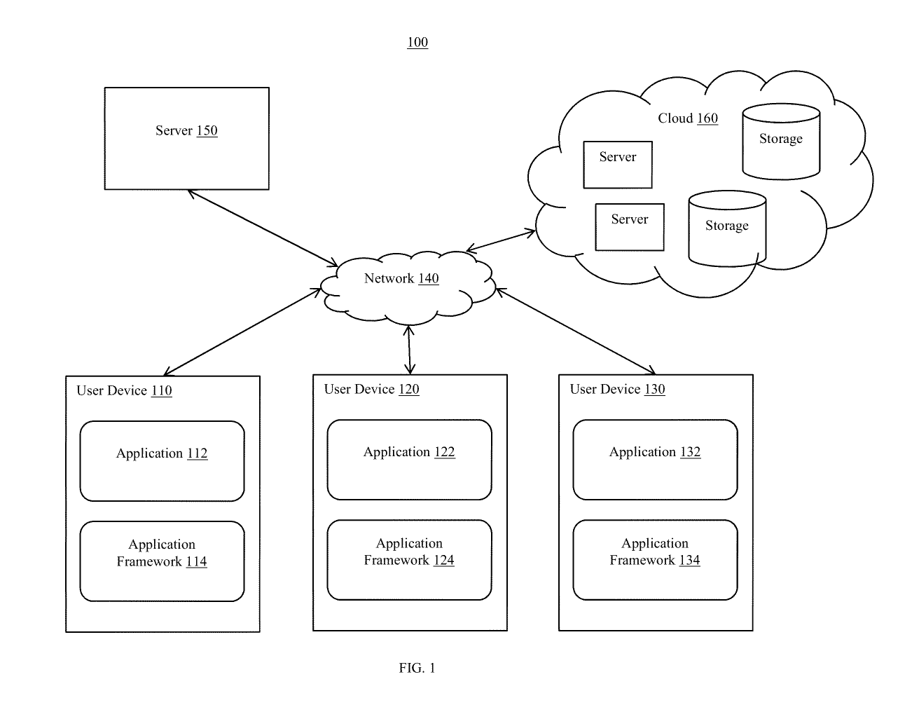

FIG. 1 depicts a block diagram of an exemplary system 100 in accordance with one or more embodiments. System 100 may include user device 110, user device 120, user device 130, network 140, server 150, and cloud 160. Although three user devices are shown in exemplary system 100, some embodiments may include any number of user devices, including one, two, three, or more.

User devices 110, 120, and 130 may each be any type of computing device, including a mobile telephone, a laptop, tablet, or desktop computer having, a netbook, a video game device, a pager, a smart phone, an ultra-mobile personal computer (UMPC), or a personal data assistant (PDA). User devices 110, 120, and 130 may run one or more applications, such as Internet browsers, voice calls, video games, videoconferencing, and email, among others. User devices 110, 120, and 130 may be any combination of computing devices. These devices may be coupled to network 140.

User devices 110, 120, and 130 may each include one or more applications or one or more application frameworks. For example, user device 110 may include application 112 and application framework 114, user device 120 may include application 122 and application framework 124, and user device 130 may include application 132 and application framework 134.

The one or more applications, including application 112, application 122, and application 132 may each be any application. An application may be implemented using software, hardware, or any combination thereof. Exemplary applications may include enterprise software, accounting software, office suites, graphics software, media players, etc. Applications may be bundled with the computer and its system software, or may be published separately.

The one or more application frameworks, including application framework 114, application framework 124, and application framework 134 may each be any application framework. An application framework may be an abstraction in which software providing generic functionality can be selectively changed by additional user written code, thus providing application specific software. An application framework may be a universal, reusable software platform used to develop applications, products and solutions. An application framework may include support programs, compilers, code libraries, an application programming interface (API) and tool sets that bring together all the different components to enable development of a project or solution.

Network 140 may provide network access, data transport and other services to the devices coupled to it. In general, network 140 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 140 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 140 may, again as an alternative or in conjunction with one or more of the above, implement a WiMAX architecture defined by the WiMAX forum. Network 140 may also comprise, for instance, a local area network (LAN), a wide area network (WAN), the Internet, a virtual LAN (VLAN), an enterprise LAN, a layer 3 virtual private network (VPN), an enterprise IP network, or any combination thereof.

Server 150 may also be any type of computing device coupled to network 140, including but not limited to a personal computer, a server computer, a series of server computers, a mini computer, and a mainframe computer, or combinations thereof. Server 150 may be a web server (or a series of servers) running a network operating system, examples of which may include but are not limited to Microsoft Windows Server, Novell NetWare, or Linux. Any of the features of server 150 may be also implemented in a distributed manner using multiple servers (not shown).

Cloud 160 may be any combination of hardware or software used to store information in a distributed and redundant manner Cloud 160 may be implemented in or managed by server 150, by one or more other servers, or any combination thereof. Cloud 160 may be distributed across a number of devices, in which each device may replicate all of the data or portions of the data stored on any combination of devices used by cloud 160. Cloud 160 may be configured to be updated in real-time when one or more of the devices housing cloud 160 receives new data. For example, when information is added to or stored on cloud 160 by server 150, the information may be distributed to other servers maintaining cloud 160 in real-time. Cloud 160 may be configured to store any type or combination of data. Cloud 160 may communicate with other devices using network 140.

Server 150 and/or cloud 160 may provide access to a database. The database may be an object database. An object database may refer to is a database management system in which information is represented in the form of objects as used in object-oriented programming. Object databases may be different from relational databases which are table-oriented. An example of an object database is ZODB, a native object database for the Python language. The object database may include internal optimization and caching for various types of data structures.

One or more application frameworks, including but not limited to application framework 114, application framework 124, and application framework 134, may provide access for an application to an object database. Access to the object database may be provided via objects and methods provided by the framework.

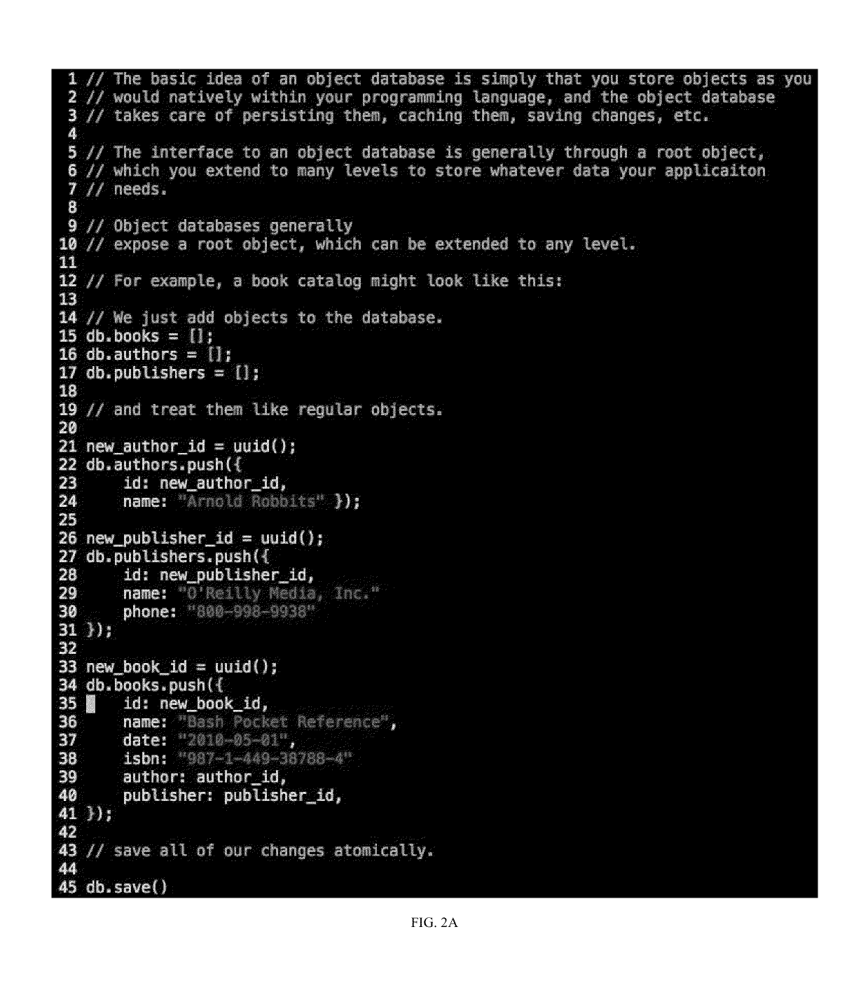

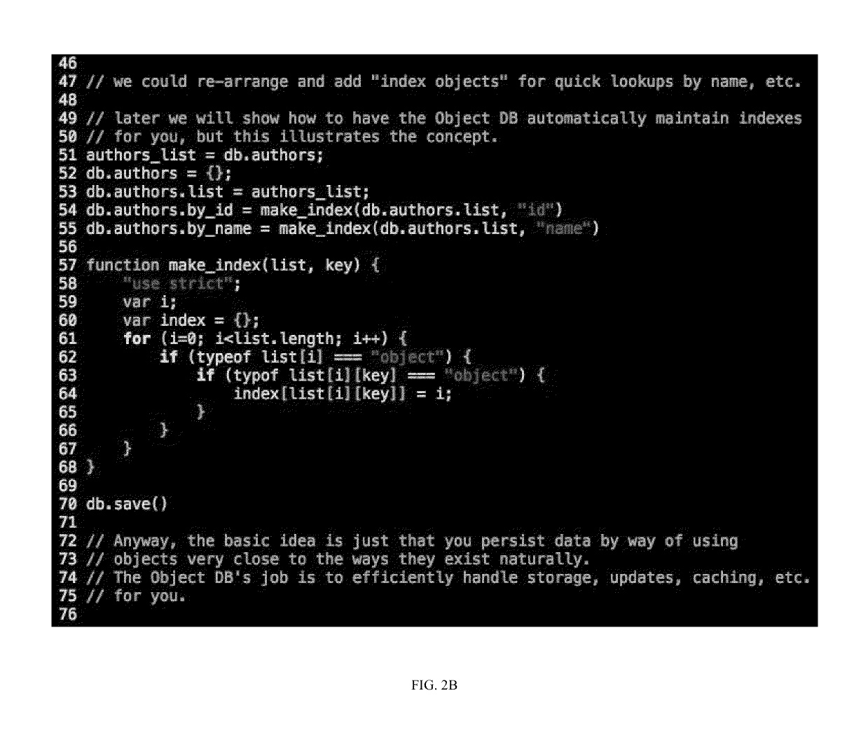

FIGS. 2A and 2B depict an exemplary program code listing for using an application framework to interact with a database in accordance with one or more embodiments. The following methods, object, functions, and interfaces may be provided and/or managed by an application framework.

Object database—Access to the database may be provided by using an object database. An object database may be typed or untyped, depending on the implementation of the framework. An object database may be used to store objects as would natively be done within a programming language. The framework manages persisting the object database, caching it, saving changes, etc.

The interface to an object database is generally through a root object, which may be extended to many levels to store whatever data an application may require. FIG. 2A depicts an exemplary interface “db” of an object database at line 15.

Adding/Modifying—An object may be added to the database, or an object in the database may be modified, by using programming code to interact with the interface just like other objects may be interacted with in the programming language.

UUID operation—UUID (universally unique identifier) operation may be a method or function invoked to produce a universally unique identifier (UUID). The UUID may be unique to the universe. A universe may be of varying scope, e.g. across an entire application, program, etc. FIG. 2A depicts an exemplary UUID operation at line 21.

Push—An object may be modified by a push operation. A push operation may add new items to the end of an array and may return the new length of the array. FIG. 2A depicts an exemplary push operation at line 21.

Save—A save operation may be called on the object database using the interface to the object database. FIG. 2A depicts an exemplary save operation at line 45. The save operation may operate atomically. When a save operation is called, all of the changes since a previous save operation on an object or since the last loading of an object may be processed by the application framework to create a transaction reflecting the changes. The framework may prepare and transmit the transaction to a server or cloud for processing and/or storage. As a result, a programmer or application may use the objects as would naturally be done when programming. Then, to commit changes, the programmer or application would call a save operation and have the application framework and the object database handle storage, updates, encryption, and caching operations.

Make_index (list, key)—Make_index function is an exemplary function for creating processing one or more objects in an object database to produce an index for the objects. FIG. 2B depicts an exemplary make_index function beginning at line 57. The make_index function may accept a list and key as parameters, and may iterate through the list to determine which object is the corresponds to the key, and adds a corresponding entry to an index structure. Upon completion, the index function may include a table of numbers indexed by the list item and key. Then, the index can be used to look up the location of an item by inputting the list item and key and receiving a value corresponding to the location in the object. For example, the location value may be an integer identifying where in an array representing the object the list item with a key may be found.

Cryptographically, changes to the object database may be batched into transactions and streamed to the server as records. Each record may update the state of the database in a specific way. A current state may the combined effects of all records.

An Object Database may be Subdivided with Containers

An object database may be subdivided using containers. A typical object database may include a single root level object. Each container may be an independent or interdependent part of the database. It may be retrieved, updated, deleted, securely shared and unshared with peers independently of other parts of the database.

Each container may have a name, e.g., a string of arbitrary length. Container names may be stored server side as the result of a keyed HMAC, so the server does not know the application level names of the container. The containers are analogous to a key-value store—except that the values may be rich. They may be structured data that evolves over time, may be updated, and has an automatic history.

Creating, retrieving, caching, and storing new containers is inexpensive in terms of operational complexity and overhead. It is often appropriate for an application to have hundreds of thousands of containers for a single user. This lets applications and developers use containers for a variety of useful purposes that are explored herein.

To access the current objects in a container, each record of a container must be retrieved from the server and processed in order to build up the end state of the container. The framework may do some automatic caching such that only new records need to be retrieved.

For expediting application load times when no local cache is available, a useful strategy is to arrange containers in a “drill down” fashion, with meta data separate from data. For example, let's consider a simple journal application and the containers it might use. This journal application is intended for data to be private to a single account (in other words, articles aren't shared with other users of the application.) Journal entries may have a, date, subject, and content. The content may be rich text and may optionally have inline attachments (such as documents, pictures, audio, or video).

A container called “journal_entries” may be used to store the metadata of all journal entries, e.g., date, subject, and entry_id. Then, one container per article may be named something similar to “journal_entry.content.entry_id,” in which the container has the actual article content, e.g. the text. In some embodiments, other containers may be used for the attachments to each entry.

The benefits of this approach are near instant application loading. When a user first logs in, even with an empty cache, the only thing they have to load immediately to begin interacting with the system is the metadata “journal_entries” container. Its contents are so minimal that even if the user saves a new article every day for 10 years, it will still load quickly. Additionally, results for searches on titles may be provided from this container without needing to access or load other containers.

When a user interacts with articles, each article that the user interacts with specifically, drilling down into it the data, may result in one or two additional container loads for content and attachments. Those should also be quick since the organization into containers means that the framework is not loading anything extra beyond the content of the article, such as unrelated objects in the object database.

Containers may be Sharable and Unsharable

A container may be sharable with one or more accounts. A container may also be viewed as always shared with at least one account, that of the container creator.

This is accomplished just by calling a share method of a container. A share method may be implemented by the framework.

Containers may have session keys for encrypting individual records. Sharing may be performed by the framework by encrypting these session keys to the public keys of the accounts the container is shared with. When a container is unshared (meaning that some account should no longer be able to read records in it), then the session key may rotated. Rotation may happen by creating a new session key, and encrypting it to the public keys of all the accounts permitted to continue reading the container.

If a developer or application wishes to implement a private journal with many entries in it, but some or all of the entries are to be shared with one or more other users, the shared entries may be copied to a derived container, and then the resulting derived container may be shared with the one or more other users.

Container Names may be Unknown to the Server

The server may not know the names of the containers that an application framework stores. Therefore, it is safe to store containers with names that are meaningful and representative of their content. For example: “journal_entry_{—}1234_attachments.”

When a new container is created, the name of the container that the server sees may actually be a modified version of the name the creator supplied, e.g., the server may see a keyed SHA256 HMAC of the name the creator supplied. The HMAC is not reversible and uses a HMAC key that may have been created during account generation. This means that two users who create a container with the same given name do not have those containers stored with the same HMAC of the name.

However, this means that some special effort is required in order to be able to ask the server for a list of all containers that are stored for a user or application. The server may provide the application framework or application with a list of all containers stored for a user or application, but not the original (unhashed) names. As a result, the application or application framework may keep track of the container names, e.g., by keep a list or storing the names in a container.

Indexed or Materialized View Containers

The contents of different containers may be indexed at the application level or by the application framework. In some embodiments, a container for every term in a lexicon is provided. A term may be a word, number, or other chunk of information. The data in each term-specific container may be a list of references to containers that include the term. When a search is performed, the term specific containers for each search term may be loaded. Then, contents of those containers may be loaded.

A search index may not need to be established prior to use of the containers. The index may be computed any time in the product's development—and maintained thereafter. The index may be used once computed.

A framework may provide plugins to create the index calculation transparently and atomically maintaining “index containers” for use by the applications each time source objects are saved. There may be a few standard types of indexers bundled with the framework, e.g. such as for natural language search. There may be hooks for adding new indexers at the application level.

For example, an index of a knowledge base of articles may be created. An application may have a very large knowledge base with 1,000,000 articles. An average article length is 5000 words, for a total of 5,000,000,000 words across all articles. A brute force search (loading every article's content and examining it for desired keywords) would be very slow and incur tremendous network IO. A solution may be to precompute an index and store it efficiently using containers. A container for every word in the lexicon may be provided. (We're ignoring issues like stemming for the moment.) The data in each word-specific container may be a list of references to articles that include the word. So when a search happens, the word specific containers for each keyword may be loaded. Then, just the articles that mentioned as references for those words may be loaded.

Container Versioning, Merging Changes, and Container Refresh

The framework may provide support for controller multiple edits to the same container. For example, in the context of the journal application discussed above, a user may have been editing two new entries—one on a laptop and another on a phone. The user hits save on both of them at about the same time, and the network arranges that both operations reach the server at nearly the same instant. In a relational database, the server can handle these two operations independently without complication. The server arranges the primary key ID numbers for example, so both inserts can get sequential IDs without conflicts.

In the framework, only the client may be able to read the contents of a container, so the server may not be able to resolve the conflict alone. To avoid conflicting updates resulting in a corrupted container, the framework may follow a simple rule: in order to update a container, the framework must know the version ID of the latest record already in the container.

When a developer or the framework sends a transaction to the server, along with each container to modify, behind the scenes the framework transmits to the server a record version identifier (ID) for a container. The server may refuse to apply the transaction if the version ID specified is not the ID of the most recent record in that container. The server may instead respond with a conflict message, telling the framework specifically which containers it needs to refresh.

The framework may then refresh those container(s), receiving just the new records from the server. Often the framework can resolve the situation and reform the transaction in much the same way the relational database would. In some rare cases, the framework may not be able to resolve the conflict automatically, and will report commit failure to the application. This possibility may be eliminated by data structure choices. In any case, the framework may report which containers have changed, and have the new contents of those containers available

Because containers may be created as a stream of records, this effectively means that they have history built into the storage medium, allowing a container's state to be observed as of a point in time. The history may be removed after a container is compacted, however.

Server Side Storage

The server may implement storage for the encrypted contents of an object database using a relational database, e.g., PostgreSQL. The object database may be implemented according to a schema. An exemplary schema is described in U.S. Provisional Patent Application Ser. No. 61/768,377, which is incorporated herein by reference in its entirety.

Each user may have an account. Each account may have a base_keyring which stores the account's asymmetric keys, various HMAC keys, and salts. Some of these may be encrypted to a key derived from their passphrase and salt.

Application users may store their data in the Object Database, in zero or more containers.

The existence of those containers may be stored in the container table. The container table does not store the keys to the containers, who they might be readable by, or any actual data going into the data. The container's data may be found in a series of records added to the container over time. Each record may change the state of the container from the previous record. Records may be encrypted with session keys.

The existence of container session keys may be stored in the container_session_key table. The actual keys may be stored in the container_session_key_share table, encrypted to the public key of the account the session key should be readable by. As a result, there may be a one-to-many relationship between session keys and session key shares. A session key may always be shared to at least one account (the author), because otherwise this would be a write only storage medium.

The records in containers may directly contain the binary data from the record itself, e.g., by using PosgreSQL's BLOBs and TOAST. In some embodiments, this may be made pluggable, so that the bulky binary parts maybe stored external to the database. For example, plugins may provide access to other storage options, e.g. https://nimbus.io/, Amazon® S3®, one or more file systems, etc.

There are also tables for application level messages, and for application transactions. Transactions may allow modifying multiple containers and messages atomically. Transactions may be created, built up to include one or more changes, and then either committed or aborted.

Internal Containers

The framework may create internal use containers, which may be identified using a naming scheme. For example, the internal use containers may be named using a prefix, e.g. “_crypton_internal.<rest of name>”, in which <rest of name> could include the rest of the container name. Internal containers may be used by the framework for a variety of purposes, such as keeping track of the real names of the containers the user's application actually uses, compaction and garbage collection history, and other meta.

Generating User Keys

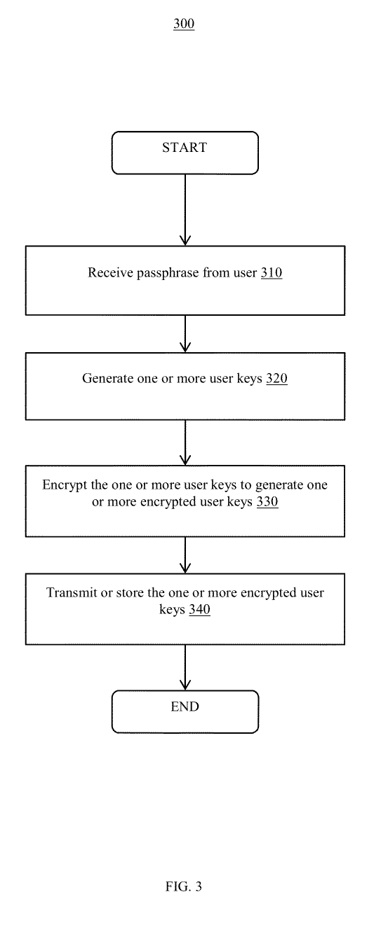

FIG. 3 depicts a block flow diagram of an exemplary method 300 in accordance with one or more embodiments. Method 300 may be used to generate one or more encrypted user keys. For illustrative purposes, method 300 will be discussed in the context of user device 110. However, method 300, either in part in or whole, may be implemented by or in combination with any one or more devices.

Method 300 may start at block 310. In block 310, a passphrase may be received from a user. User device 110, application 112, application framework 114, or any combination thereof may receive the passphrase. A passphrase may be any sequence of characters, numbers, and/or symbols that may be used to help control access. For the avoidance of doubt, a passphrase in the framework doesn't “control” access in the sense of policy. It makes information available, in the sense that with the passphrase, a cryptographic key can be calculated using the passphrase with a Key Derivation Algorithm. Without the passphrase, the key is unknowable.

In block 320, one or more user keys may be generated. The one or more user keys may be generated by user device 110, application 112, application framework 114, or any combination thereof. The one or more user keys may be used for encryption, decryption, or any other cryptographic function. A key may be a piece of information that determines the functional output of a cryptographic algorithm or cipher. Without a key, the algorithm may not produce a useful result. In encryption, a key may specify the particular transformation of plaintext into ciphertext, or vice versa during decryption. A key may be used in other cryptographic algorithms, such as digital signature schemes and message authentication codes. Exemplary user keys may include private keys, public keys, public/private key pairs, symmetrical key, authentication keys, etc.

In block 330, the one or more user keys may be encrypted using the passphrase to generate one or more encrypted user keys. The one or more user keys may be encrypted by user device 110, application 112, application framework 114, or any combination thereof. The one or more encrypted user keys may be encrypted such that they cannot be decrypted without knowledge of the passphrase. The one or more encrypted user keys may be encrypted using a symmetric cipher such as AES, Blowfish, RC4, etc. In some embodiments, application framework 114 may generate the one or more user keys and encrypt the one or more user keys using the passphrase to generate the one or more encrypted user keys.

In block 340, the one or more encrypted user keys may be transmitted, stored, or any combination thereof by user device 110, application 112, or application 114. In some embodiments, the one or more encrypted user keys may be transmitted to another device or computing system. For example, the one or more encrypted user keys may be transmitted to server 150 and/or cloud 160, where they may be stored.

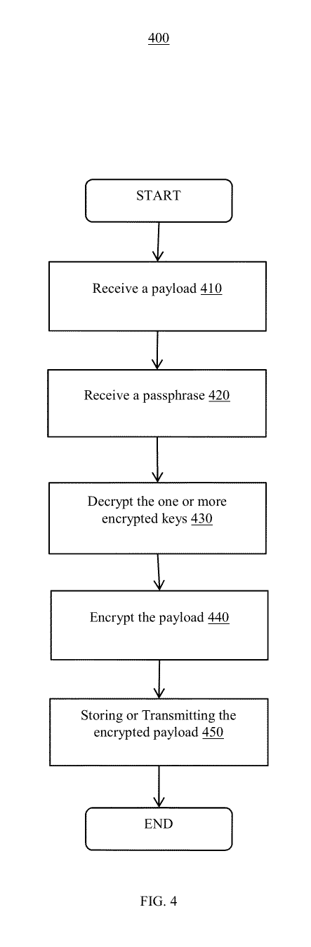

FIG. 4 depicts a block flow diagram of an exemplary method 400 in accordance with one or more embodiments. Method 400 may be used to encrypt one or more payloads. For illustrative purposes, method 400 will be discussed in the context of user device 110. However, method 400, either in part in or whole, may be implemented by or in combination with any one or more devices.

Encrypting a Payload

Method 400 may start at block 410. In block 410, a payload may be received. The payload may be received by user device 110, application 112, or application framework 114.

A payload may be any type of machine storable information, including but not limited to an object, a container, a transaction, a message, etc. A payload may include encrypted or unencrypted information. For example, a payload may include a programming object, an encrypted programming object, or any combination thereof. An object may be a data structure in any standard format. An object may be serializable. For example, the object included in a payload may be serializable using JavaScript Object Notation (JSON), which is a text-based open standard designed for data interchange. Despite its relationship to JavaScript, JSON may be language-independent. Although JSON is discussed as an exemplary standard for serialization, any serialization standard or scheme may be used. In some embodiments, the payload may comprise an application-level message. For example, the payload may include a message originating from one application intended for a second application, whether on the device or not.

In block 420, a passphrase may be received. User device 110, application 112, application framework 114, or any combination thereof may receive the passphrase. The passphrase may be received from a user.

In block 430, one or more encrypted user keys may be decrypted using the passphrase to produce one or more user keys. User device 110, application 112, application framework 114, or any combination thereof may decrypt the one or more encrypted user keys. The one or more encrypted user keys may be received from user device 110, application 112, application framework 114, or any combination thereof. In some embodiments, the one or more encrypted user keys may be received with a payload. In some embodiments, the one or more encrypted user keys may be received separately from a payload.

In block 440, the payload may be encrypted using the one or more user keys to produce an encrypted payload. The payload may be encrypted by user device 110, application 112, application framework 114, or any combination thereof.

In block 450, the encrypted payload may be transmitted, stored, or any combination thereof by user device 110, application 112, or application 114. In some embodiments, the encrypted payload may be transmitted to another device or computing system. For example, the encrypted payload may be transmitted to server 150 and/or cloud 160, where it may be stored.

In some embodiments, the encrypted payload may represent or include a transaction. A transaction may refer to a related series of changes intended to be applied atomically, in which many changes are made as an indivisible unit. This is similar to a relational database with ACID properties, in which a full collection of changes may either complete entirely or fail entirely. For example, a transaction may move data from one container to another by simultaneously applying a delete instruction to the first container and a add instruction to the next. This means that an application may make changes across one or more containers and guarantee consistency. In addition to creating, modifying, and deleting any number of containers, containers may also be shared, unshared, and messages may be created and deleted with the guarantee of consistency. A transaction may include the differences between data objects.

Decrypting a Payload

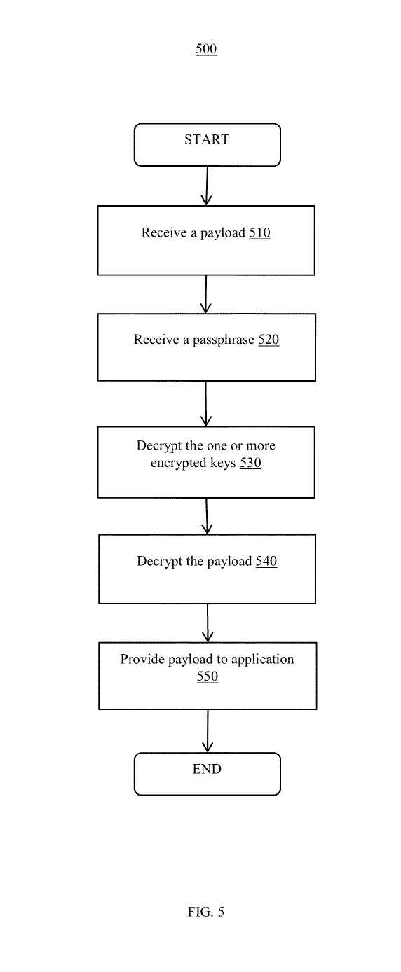

FIG. 5 depicts a block flow diagram of an exemplary method 500 in accordance with one or more embodiments. Method 500 may be used to decrypt one or more payloads. For illustrative purposes, method 500 will be discussed in the context of user device 110. However, method 500, either in part in or whole, may be implemented by or in combination with any one or more devices.

Method 500 may start at block 510. In block 510, a payload may be received. The payload may be received by user device 110, application 112, or application framework 114. The payload may be any type of machine storable information, and may include encrypted or unencrypted information. For example, the payload may include a message originating from one application intended for a second application, whether on the device or not.

In block 520, a passphrase may be received. User device 110, application 112, application framework 114, or any combination thereof may receive the passphrase. The passphrase may be received from a user.

In block 530, one or more encrypted user keys may be decrypted using the passphrase to produce one or more user keys. User device 110, application 112, application framework 114, or any combination thereof may decrypt the one or more encrypted user keys. The one or more encrypted user keys may be received from user device 110, application 112, application framework 114, or any combination thereof. In some embodiments, the one or more encrypted user keys may be received with a payload. In some embodiments, the one or more encrypted user keys may be received separately from a payload.

In block 540, the payload may be decrypted using the one or more user keys to produce a decrypted payload. The payload may be decrypted by user device 110, application 112, application framework 114, or any combination thereof.

In block 550, the decrypted payload may be provided to application 112. The decrypted payload may be provided to application 112 by application framework 114. In some embodiments, providing the decrypted payload to application 112 may include further processing the payload, either by application 112 or application framework 114. For example, the decrypted payload may be deserialized into an object. In some embodiments, the decrypted payload may represent or include a transaction.

Exemplary Application, Framework, and Server Interactions

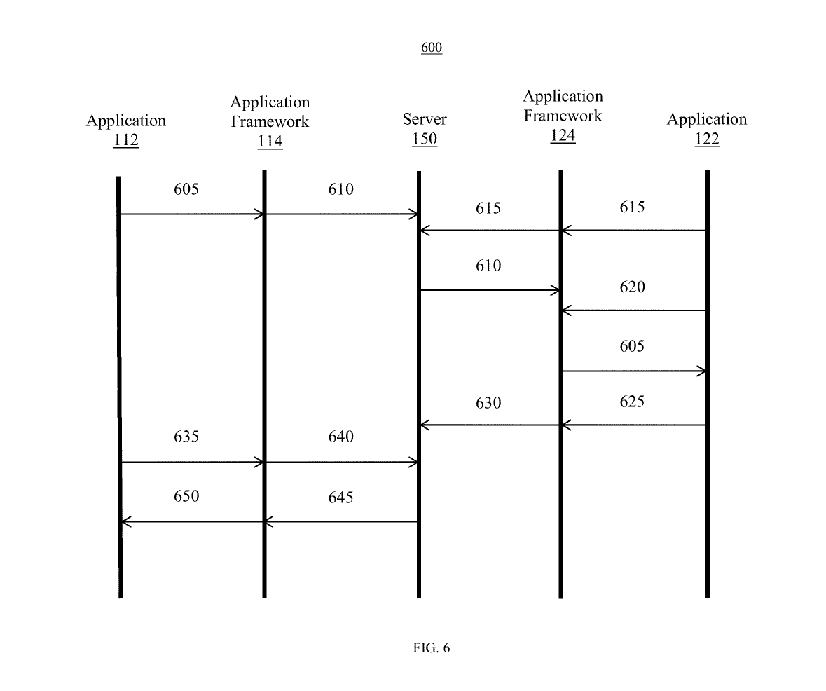

FIG. 6 depicts a data flow diagram 600 in accordance with one or more embodiments. For illustrative purposes, data flow diagram 600 will be discussed in the context of applications 112 and 122, application frameworks 114 and 124, and server 150. However, data flow diagram 600, either in part in or whole, may be implemented by or in combination with any one or more devices, applications, and application frameworks.

An payload may be encrypted and sent to server 150 from user device 110. For example, a payload 605 may be sent from application 112 to application framework 114. Application 112 may also provide application framework 114 with a passphrase. Payload 605 may include or be a data object used by application 112. Application framework 114 may serialize and encrypt payload 605 into encrypted payload 610 using the one or more user keys, which may be retrieved by application framework 114 by decrypting one or more encrypted user keys using the passphrase. Application framework 114 may transmit encrypted payload 610 to server 150 where it may be stored. Although encrypted payload 610 is shown being transmitted to and stored on server 150, the encrypted payload 610 could have been transmitted and store on cloud 160 or one or more other devices.

A second user device 120 may request the object in payload 605 stored on server 150. Application 122 may send request 615 for the object in payload 605 to application framework 124, which may then send the request 615 to server 150. The server 150 may send encrypted payload 610 to application framework 124. Server 150 may also send the one or more encrypted user keys to application framework 124. Application framework 124 may receive passphrase 620 from application 122. Application framework 124 may decrypt the one or more encrypted user keys, and then use the decrypted user keys to decrypt encrypted payload 610 and/or deserialize the decrypted payload into the object from payload 605. Application framework 124 may provide the payload 605, the object, or both to application 122.

Application 122 may make modification to the object retrieved from payload 605. In some embodiments, Application framework 124 may use methods 400, 500, or the process described above to receive the modified object 625 from application 122, encrypt the modified object, and send the encrypted modified object to server 150. In some embodiments, application framework 124 may receive the modified object 625 and may create a transaction object representing the differences between the modified object the original object from payload 605. The transaction object may be included in or make up a payload which may be then encrypted using the one or more user keys to produce encrypted transaction 630. Encrypted transaction 630 may be sent to and stored by server 150.

Server 150 may store transaction information for all of the encrypted payloads received by it and/or stored on it. Transaction information may include a date of creation and/or modification of the payload, a time of creation and/or modification of the payload, a sequence number of the transaction, an identify of a previous object or transaction, a name and/or identifier of the object to which the transaction relates, or any combination thereof. All or part of the transaction information may be stored in a database on server 150, on one or more other devices, or any combination thereof.

Application 112 may send a request 635 that application framework 114 check server 150 for updates to the object originally in payload 605. Application framework 114 may forward the request 635 as request 640 to server 150, or application framework may create a new request 640. Request 640 may include a record version identifier of a container.

Server 150 may process the request 640, which may include processing multiple updates to an object in order to create a single transaction to update the object. Creating a single transaction object may be created when request 640, when the updates are received, or any time in between. Server 150 may respond to request 640 respond by sending a response 645, which is encrypted by the one or more user keys, to application framework 114. The response 645 may include one or more encrypted transaction payloads or an encrypted payload. Server 150 may also send the one or more encrypted user keys to application framework 114.

Application framework 114 may receive the passphrase from application 112. Application framework 114 may decrypt the one or more encrypted user keys, and then use the one or more decrypted user keys to decrypt response 645 and/or deserialize the decrypted payload into an updated object. Application framework 114 may provide the decrypted payload 650, which may include or be the object, to application 112.

In some embodiments, an application or application framework may store cached versions of objects. The cached versions may lessen the number of transactions or objected needed to be transferred when updating an object.

The techniques described in FIG. 3 may be used to generate the one or more encrypted user keys used in exemplary data flow diagram 600. The techniques described in FIG. 4 and/or in FIG. 5 may be used for encrypting and/or decrypting the objects and/or payloads used in exemplary data flow diagram 600.

The techniques described herein may be used to provide distributed encrypted payloads and/or encrypted user keys across devices, applications, and frameworks, in a manner that prevents the distributed devices, applications, and frameworks from accessing the user keys without the passphrase used to encrypt the keys. As a result, developers can easily create applications that store information securely, redundantly, and without concern that people with access to the devices, applications, and frameworks can access the stored information.

Application Level Messaging

In some embodiments, the techniques described herein may be used to provide secure application-level messaging. For illustrative purposes, secure application-level messaging will be discussed in the context of user devices 110 and 120, applications 112 and 122, and application frameworks 114 and 124. However, secure application-level messaging, either in part in or whole, may be implemented by or in combination with any one or more devices, applications, and frameworks. For example, securing messaging may be implemented using different devices, on the same device using different applications and/or application frameworks, on the same device using the same application framework, etc. An application-level message may refer to a message sent from one application to another application or to the same application. For example, application 112 may encapsulate a message in a payload and request that application framework 114 encrypt it for transmission to application 122. Using a passphrase, application framework 114 decrypt one or more encrypted user keys, use the one or more user keys to encrypt the message payload, and send the one or more encrypted keys and the encrypted message payload to application framework 124. Application framework 124 may use the method depicted in FIG. 5 to decrypt the encrypted message payload, and provide the result to application 122. Serialization and/or deserialization may be performed on the message or message payload.

To support message based application design, the framework may make is possible for an application of one user account to request to add a message to the “inbox” of another user account (including the author). To be clear, these are application level messages—messages between programs—and not necessarily messages between humans. The message may have a particular meaning as interpreted by the receiving application or account. For example, a message may be indicated mean something like: I've shared a new container with you—go check it out. A chat application might exclusively use messages. Messages may have a header, which may be but is not required to be limited to 4 kilobytes, and a payload. The message may also have an optional time-to-live for specifying that a message only has transient value. The parts of the message may be encrypted.

Other application users retrieve the messages in their inbox by polling or receiving realtime notifications

Multiple User Access to a Container

In some embodiments, multiple users may have access to the same encrypted object. Each user may have a respective passphrase. Each passphrase may provide access to one or more user keys that are encrypted. The one or more user keys may include a private key for each user. The public keys of the users may be provided to other users unencrypted and freely accessed by the other users. When a user encrypts an object, the user may create multiple encrypted versions of the object, in which each encrypted version may be encrypted using a public key of a user in the group. As a result, each user can decrypt at least one of the multiple encrypted versions using the user's private key, which may only be accessible with the user's passphrase. Other techniques for providing multiple user access to a container are discussed herein.

In some embodiments, a two levels of one or more keys may be used. The first-level keys may correspond to the one or more user keys described above regarding FIGS. 3, 4, and 5, i.e., keys encrypted using the passphrase. The first-level keys, once decrypted, may then be used as a second passphrase to access encrypted second-level keys. The second-level keys, once decrypted, may be used to encrypt or decrypt payloads or objects. One advantage of using two levels of keys is that it allows one or more users to be easily removed from an access group without having to re-encrypt the one or more objects to which the group has access. For example, if a user leaves a group having access to an object, a new set of first-level keys may be generated for each member of the remaining access group members, but the second-level keys may remain the same.

Use of Multiple Encrypted Objects for Data Management

In some embodiments, multiple encrypted objects may be used to reduce the amount of accesses and/or updates of objects. For example, a journaling application may use a metadata object that is securely stored and distributed using the techniques discussed herein. The metadata object may include references, journal entries, etc., each of which may be securely stored and distributed using the techniques discussed herein. In this type of implementation, an application need only load, and if necessary update, the metadata object to determine which entries need to be loaded, updated, or displayed. This is in comparison to an application that stores all of the journal entries in a single securely stored and distributed object, in which the entire object may need to be compared, updated, and/or redistributed upon any possible change.

Collaborative Whiteboard

In some embodiments, a collaborative whiteboard may be provided using the framework. The collaborative whiteboard is an example of an application and data structures that may be developed using the framework but not directly provided by the framework. Suppose two users, e.g. Alice and Bob, wish to share a collaborative whiteboard where they can privately draw pictures. The whiteboard may be implemented as a canvas with point coordinates. All coordinates start out white. By default, Alice makes makes marks in a color (e.g. red) and Bob makes marks in another color (e.g. blue).

Alice open the application and creates a new whiteboard. Like in the journal application, the application may separate metadata from data. So the existence of this whiteboard, along with meta information like the date and a title, is stored in a listing container. There may be another container for the content of just this one whiteboard.

Alice shares her whiteboard container with Bob. She sends an application level message to Bob telling him this whiteboard exists along with its name.

Bob's application receives the notification that Alice has shared a new whiteboard with him. He chooses to collaborate. The application automatically adds a new whiteboard entry to bob's meta container, and starts a new container for this whiteboard. He shares this container with Alice, and sends her application a message telling her the reciprocal container he has shared.

Alice's application watches Bob's container for changes. Bob's application watches Alice's container for changes. Both receive real-time events with the new records either creates in their own containers.

On Alice's screen, she sees a series of drawing tools (pencil, eraser, text type, etc) she can use to modify the whiteboard. Each modification she makes becomes a new record stored to her container, describing the drawing mark she made.

On Bob's screen, his application is watching Alice's shared container, and draws each of her marks as they are received. Bob draws his own marks and Alice sees blue.

Every event put into the containers may have some meta information along with it: an ID, a timestamp, and the ID of the most recent mark the application was aware of before this one. These allow simple cases where both people are drawing on the same coordinates at once to be sorted out automatically. Erasing is just another kind of mark, drawn with white instead of red or blue. Sophisticated marks (typography, etc.) are stored as either pure vectors or if necessary vectors with rasterized portions.

What's significant in this approach is that Bob and Alice don't need to write to each other's' containers. There's no read/write access controls needed. On top of simple, two way real time sharing, we've built a collaborative tool. Alice and Bob can each have private whiteboards available only to themselves, and those they share with others.

File and Backup Service

In some embodiments, the framework may be used to develop a file and backup service. This file and backup service is an example of an application and data structures that may be developed using the framework but not directly provided by the framework. A user may want to backup the user's large collection of files. This may include, for example, millions of lines of source code, extensive collection of music, pictures, etc.

The user may want to be able to login to the user's online file manager and immediately start browsing her files, much like the user would in the user's operating system, quickly opening folders and subfolders, drilling down until the user finds a particular item.

To implement the file system, one container (maybe called a folder_tree) may just record a map of the paths of folders, i.e., which folders exist, what their paths are, and a reference to another container for their contents. This may be stored as a dictionary with all paths flattened and specified absolutely, e.g. “C:\Users\Alice\Documents\Music\Euro\” may maps to the name of a container that has the metadata for the contents of that folder.

One container per folder may be used for the files, e.g. everything but folders, inside that particular folder. Again, only store the metadata about these files may be stored. References to other containers may be stored for the binary contents. One container per unique file may be used for binary content. These might be named based on a hash, e.g. a sha256 hash, of their content to get file level duplication.

This arrangement may allow an application to present a user with a very interactive experience. When the user first logs into the online file manager, the user can very quickly retrieve one small container and see the hierarchy of folders. The user can navigate and open any folder, causing another small container retrieve to see that one folder's contents. Downloading any particular file retrieves a container with just that data in it.

Application Deployment, Distribution, and Threat Models

There are a variety of ways that the framework may be used for developing, packing, deploying, and hosting applications. Some example scenarios, which include examples of applications and data structures that may be developed using the framework but not directly provided by the framework, and which could happen in combination, may include:

A user that builds an application leveraging the framework that stores data via storage servers operated by the user.

Like above, except the user uses one or more servers provided by a third party, e.g. by SpiderOak. Data may be stored inside the end-user's SpiderOak accounts on SpiderOak servers.

The user may distribute the user's application, which makes use of the framework, in the form of pre-packaged, signed, verifiable open source desktop and/or mobile applications.

The user may makes a browser based application that makes use of the framework and stores information on servers, and serves the application code from servers controlled by the user.

Like above, except the user works with a trusted hosting provider to host and serve the web application source code. The trusted hosting provider may certify the source code.

Exemplary Computing Device Architecture

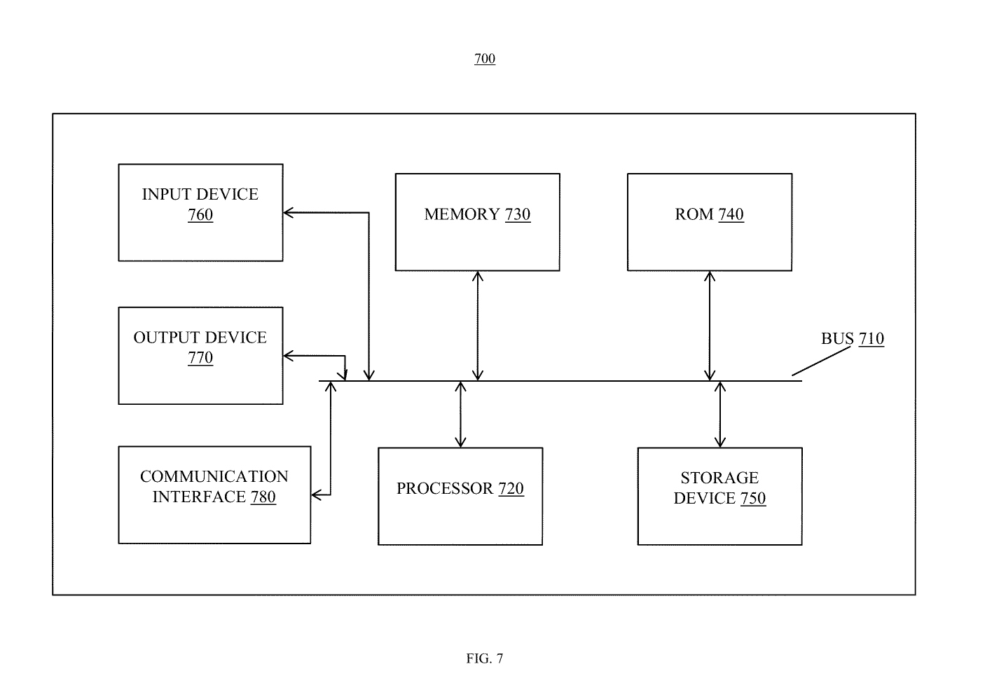

FIG. 7 depicts an exemplary architecture for implementing a computing device 700 in accordance with one or more embodiments, which may be used to implement any of the user devices, servers, cloud, or any other computer system or computing device component thereof. It will be appreciated that other devices that can be used with the computing device 700, such as a client or a server, may be similarly configured. As illustrated in FIG. 7, computing device 700 may include a bus 710, a processor 720, a memory 730, a read only memory (ROM) 740, a storage device 750, an input device 760, an output device 770, and a communication interface 780.

Bus 710 may include one or more interconnects that permit communication among the components of computing device 700. Processor 720 may include any type of processor, microprocessor, or processing logic that may interpret and execute instructions (e.g., a field programmable gate array (FPGA)). Processor 720 may include a single device (e.g., a single core) and/or a group of devices (e.g., multi-core). Memory 730 may include a random access memory (RAM) or another type of dynamic storage device that may store information and instructions for execution by processor 720. Memory 730 may also be used to store temporary variables or other intermediate information during execution of instructions by processor 720.

ROM 740 may include a ROM device and/or another type of static storage device that may store static information and instructions for processor 720. Storage device 750 may include a magnetic disk and/or optical disk and its corresponding drive for storing information and/or instructions. Storage device 750 may include a single storage device or multiple storage devices, such as multiple storage devices operating in parallel. Moreover, storage device 750 may reside locally on the computing device 700 and/or may be remote with respect to a server and connected thereto via network and/or another type of connection, such as a dedicated link or channel.

Input device 760 may include any mechanism or combination of mechanisms that permit an operator to input information to computing device 700, such as a keyboard, a mouse, a touch sensitive display device, a microphone, a pen-based pointing device, and/or a biometric input device, such as a voice recognition device and/or a finger print scanning device. Output device 770 may include any mechanism or combination of mechanisms that outputs information to the operator, including a display, a printer, a speaker, etc.

Communication interface 780 may include any transceiver-like mechanism that enables computing device 700 to communicate with other devices and/or systems, such as a client, a server, a license manager, a vendor, etc. For example, communication interface 780 may include one or more interfaces, such as a first interface coupled to a network and/or a second interface coupled to a license manager. Alternatively, communication interface 780 may include other mechanisms (e.g., a wireless interface) for communicating via a network, such as a wireless network. In one implementation, communication interface 780 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 700 may perform certain functions in response to processor 720 executing software instructions contained in a computer-readable medium, such as memory 730. In alternative embodiments, hardwired circuitry may be used in place of or in combination with software instructions to implement features consistent with principles of the disclosure. Thus, implementations consistent with principles of the disclosure are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While various exemplary embodiments have been described above, it should be understood that they have been presented by way of example only, and not limitation. Thus, the breadth and scope of the present disclosure should not be limited by any of the above-described exemplary embodiments, but should instead be defined only in accordance with the following claims and their equivalents.

1. A method for storing data securely, the method comprising:
receiving, by an application framework implemented by a computing system, a payload from an application;
receiving, by the application framework, a passphrase;
decrypting at least one encrypted user key using the passphrase to produce at least one user key;
encrypting the payload using the at least one user key to produce an encrypted payload, and
storing or transmitting the encrypted payload.

2. The method of claim 1 further comprising:
receiving the passphrase from a user;
generating, by the application framework, the at least one user key; and
encrypting, by the application framework, the at least one user key using the passphrase to generate the at least one encrypted user key.

3. The method of claim 1 further comprising:
transmitting the at least one encrypted user key to a second computing system.

4. The method of claim 1 further comprising:
storing the at least one encrypted user key on the computing system.

5. The method of claim 1, wherein the payload comprises at least one of:
an object; and
an encrypted object.

6. The method of claim 5 wherein the object is serializable.

7. The method of claim 1 wherein the at least one user key comprises at least one of:
a public key;
a private key;
a public-private key pair; and
a symmetric key.

8. The method of claim 1, wherein the payload is encrypted or decrypted by a second application framework prior to encrypting the payload using the at least one user key to produce the encrypted payload.

9. The method of claim 8 further comprising:
wherein payload comprises an application-level message.

10. The method of claim 1 further comprising:
receiving a second payload;
creating a transaction representing a difference between the payload and the second payload;
encrypting the transaction to produce an encrypted transaction; and
storing or transmitting the encrypted transaction.

11. A method for storing data securely, the method comprising:
receiving, by an application framework implemented by a computing system, a payload from an application;
receiving, by the application framework, a passphrase;
decrypting at least one encrypted user key using the passphrase to produce at least one user key;
decrypting the payload using the at least one user key to produce a decrypted payload; and
providing, by the application framework, the decrypted payload to the application.

12. The method of claim 11, wherein the payload is encrypted or decrypted by a second application framework prior to decrypting the payload using the at least one user key to produce the decrypted payload.

13. A system for storing data securely, the system comprising:
a computing system; and
a database comprising:
containers, wherein each container is identified by a container identifier and comprises at least one record;
a container session key table configured to store the container identifiers of the containers;
a container session key share table configured to store encrypted user keys; and
a container session key table configured to store session key shares, wherein each session key share corresponds to at least one encrypted user key;
wherein the computing system is configured to:
transmit a request for a requested container to the database, the request comprising a requested container identifier of the requested container;
receive the requested container from the database, wherein the database provides the requested container by using the container session key table to identify the requested container;
receive an encrypted user key corresponding to the requested container from the database; and
transmit the requested container and the encrypted user key to an application framework.

14. The system of claim 13, wherein the database is an object database.

15. The system of claim 13, wherein a record of at least one of the containers comprises application data.

16. The system of claim 13, wherein each of encrypted user keys is encrypted with a public key of a user corresponding to the user key.

17. The system of claim 13, wherein the application framework is implemented on a user device.

18. A computer readable storage medium for storing data securely, the computer readable storage medium comprising instructions that if executed enables a computing system to:
transmit a request for a requested container to a database, the request comprising a requested container identifier of the requested container, wherein the database comprises:
containers, wherein each container is identified by a container identifier and comprises at least one record,
a container session key table configured to store the container identifiers of the containers,
a container session key share table configured to store encrypted user keys, and
a container session key table configured to store session key shares, wherein each session key share corresponds to at least one encrypted user key;
receive the requested container from the database, wherein the database provides the requested container by using the container session key table to identify the requested container;
receive an encrypted user key corresponding to the requested container from the database; and
transmit the requested container and the encrypted user key to an application framework.

19. The computer readable storage medium of claim 18, wherein the database is an object database.

20. The computer readable storage medium of claim 18, wherein a record of at least one of the containers comprises application data.

21. The computer readable storage medium of claim 18, wherein each of encrypted user keys is encrypted with a public key of a user corresponding to the user key.

22. The computer readable storage medium of claim 18, wherein the application framework is implemented on a user device.
